(19) United States
(12) Patent Application Publication
(10) Pub. No.: US 2018/0340343 A1
(43) Pub. Date: Nov. 29, 2018

(54) TILT-UP CONSTRUCTION BRACE POSITIONING TOOL AND METHOD

(71) Applicant: Gregory H. Carpenter, Lodi, CA (US)

(72) Inventor: Gregory H. Carpenter, Lodi, CA (US)

(21) Appl. No.: 15/987,672

(22) Filed: May 23, 2018

Related U.S. Application Data
(60) Provisional application No. 62/510,548, filed on May 24, 2017.

(51) Int. Cl. E04G 21/18; E04G 21/26; B66F 9/18

(52) U.S. Cl. CPC E04G 21/1841; E04G 21/165; B66F 9/18; E04G 21/26

(57) ABSTRACT

An attachment for a reach lift or other construction vehicle provides a saddle assembly or other rest for supporting a brace thereon, for ease in positioning a brace, such as adjacent to a wall of a tilt-up building. The saddle assembly is mounted on the attachment to a lateral side thereof and facilitates tilting and optionally also pivoting for control of position and orientation of the brace as it is maneuvered into position, and held by the attachment. The saddle assembly in one form includes a trough in which the brace can rest. The trough is typically mounted to a collar which is tiltably placed upon a shaft supported by a base of the attachment, with the collar facilitating tilting. A removable clasp or other fastener removably secures the brace to the trough of the saddle assembly or other brace rest.

### CROSS-REFERENCE TO RELATED APPLICATIONS

This application claims benefit under Title 35, United States Code § 119(e) of U.S. Provisional Application No. 62/510,548 filed on May 24, 2017.

### FIELD OF THE INVENTION

The following invention relates to attachments for reach lift type construction vehicles and other construction vehicles. More particularly, this invention relates to the placement of braces and other elongate objects adjacent to walls, such as walls of tilt-up construction structures, and utilization of reach lift construction vehicles with appropriate attachments to facilitate brace placement.

### BACKGROUND OF THE INVENTION

One technique for manufacturing buildings is to form walls of the buildings with concrete, by providing forms for the walls on a horizontal surface, pouring the concrete into the forms, and then after the concrete hardens, tilting up the concrete walls into a vertical plane forming a wall of the building. Such buildings are often referred to as “tilt-ups” due to the way that they're manufactured.

One important element used in tilt-up construction is the “brace.” The brace is an elongate rigid high-strength member which is placed diagonally against a tilt-up wall after the wall has been tilted into position. The brace stabilizes the wall until other walls of the building can be constructed, tilted in the position and connected to the braced wall. Furthermore, the roof also helps to stabilize the wall, so that the braces benefit from remaining in place until the roof has also been placed onto the tilt-up building. Braces can be used adjacent to other walls or other structures as well.

A typical brace is a tubular steel member which has a length similar to a height of the tilt-up wall to be braced. This brace will then be attached, such as approximately two-thirds of the way up the tilt-up wall and then extend diagonally down to a lower end which is secured to ground or other stationary objects outside (or inside) of the building. Because many tilt-up buildings are thirty feet or more tall, the braces are similarly quite long. Also, such braces typically have a diameter of approximately four to six inches and a wall thickness of about one-quarter inch to one-half inch (or more). The resulting brace is quite often 250 pounds or more in weight. Thus, moving and positioning the brace can be quite a task, generally involving a team of individuals or a crane, and being a rather slow and tedious (and also somewhat dangerous) process.

When a wall of a tilt-up building is tilted up, such tilting up of the wall is typically performed by a crane. A variety of different pieces of machinery are on site to work on the wall, before, during and after it is tilted up into position. Every piece of machinery has an associated cost, with larger equipment, such as cranes, being the most expensive. Furthermore, cranes are not particularly mobile and tend to be relatively slow moving, which is good for the very largest structures, but can be an impediment when handling structures of intermediate size and weight, which are too heavy for an individual or group of individuals to easily manage, but too small and/or light to make efficient use of equipment such as cranes.

One machine which is of versatile use on a tilt-up job site is a “reach lift” vehicle (also referred to as a “telescopic handler,” a “teleporter” and a “telehandler”). Vehicles generally in the reach lift category typically have a wheeled base and a motor with a drive coupled to at least some of the wheels, so that the wheeled base can be driven about. A boom extends from the wheeled base and this boom can be pivoted from horizontal to vertical. The boom is also configured so that it can telescope, so that a tip of the boom can be extended and retracted relative to the wheeled base. An upper end of this telescoping boom can be fitted with various different attachments. One attachment is a fork attachment which allows for pallets and other structures with fork receivers to be mounted onto the forks at the distal end of the boom. Another common structure at the distal end of the boom is a man carrying basket. Many such reach lifts are configured so that they can be driven from such a man carrying basket, so that an operator on the distal end of the boom can move the reach lift to desired location and extend and retract the distal end of the boom, as well as pivot the boom up-and-down, so that the distal end can be position where desired. Other reach lifts are driven from an operator cab on the wheeled base.

With the prevalence of reach lifts on a tilt-up construction job site, and the need to position braces after a wall has been tilted up in a manner that is as efficient as possible, a need exists to facilitate the placement of braces against a tilt-up wall. Methods and apparatuses utilizing a reach lift vehicle would be particularly useful.

### SUMMARY OF THE INVENTION

With this invention, an attachment for a reach lift (or similar vehicle) is provided which allows for a brace to be carried about on a job site and placed in position, such as bracing a wall (typically a concrete wall) that has been tilted up to form a portion of a tilt-up building. The attachment of this invention, according to an exemplary embodiment, begins with an attachment base or other elevatable operating point. In one form, this base is a rigid structure having a pair of fork receivers into which front forks at a distal end of a reach lift can be placed. These fork receivers are generally in the form of tunnels with a rectangular cross-section which are parallel and spaced apart by a distance similar to a space in between two forks on the distal end of the reach lift. Preferably skids are provided below each fork receiver to interface with the ground. Furthermore, cross members preferably join the two fork receivers together to maintain their parallel and appropriately spaced orientation relative to each other. Preferably, a safety chain or other securing device is provided on this attachment base which allows the attachment base to be secured for safety to the forks or other portions at the distal end of the reach lift, so that the attachment base cannot fall off of the forks at the distal end of the reach lift.

Distal ends of the fork receivers (or other distal portions of the attachment base) include a journal sleeve thereon in this embodiment. This journal sleeve extends generally perpendicular to the fork receivers and is preferably generally in the form of a pipe having a circular cross-section and which is at least as long as a total width of the attachment base between outboard edges of the two fork receivers. In one embodiment, the journal sleeve is welded to an angle iron and otherwise affixed to the fork receivers so that the journal sleeve is strongly supported and held firmly to the distal ends of the fork receivers, and extending generally horizontally and perpendicular to the direction in which the forks extend.

Preferably, this journal bearing is reversible so that a brace support saddle assembly associated with this attachment (described below) can be placed pivotably extending from either end of this journal sleeve (and out to the left or the right of the attachment base). An elongate shaft fits within this journal sleeve which is preferably an elongate steel member sized just small enough to fit within the journal sleeve. Typically, this shaft is sufficiently long so that it extends out each end of the journal sleeve. If desired, a pic can be fastened to the journal sleeve at an end thereof opposite a functioning tip, so that the shaft can be temporarily held to the journal sleeve. A pair of plates extend radially from the shaft in parallel planes, with one of these plates acting as a journal plate going against an end of the journal sleeve adjacent to where the brace supporting saddle assembly is to be located, and the saddle plate is placed closer to the distal tip of the shaft (at the functional end thereof) than is the journal plate, with the spacing between the journal plate and the saddle plate defining an offset distance between the attachment base and the saddle assembly which supports the brace thereon.

The saddle assembly is configured to be removably attached to a brace and to provide two degrees of freedom (most preferably) relative to the attachment base. The saddle assembly includes a collar which slides onto the tip of the shaft and up against the saddle plate. The shaft is configured to rotate inside the journal sleeve, or the collar is configured to rotate upon the shaft (or both). A first degree of freedom (generally referred to as “tilt”) is thus provided, which can be generally referred to as rotation about an X-axis. This X-axis can generally be considered to be a horizontal axis perpendicular to the direction of reach lift vehicle movement and also considered to be generally perpendicular to a telescoping axis of the boom of the reach lift vehicle.

The saddle assembly is configured to resist rotation about the Y-axis (defined as the direction of reach lift vehicle movement and direction in which the distal end of the reach lift telescopes when the reach lift is oriented horizontally). The saddle assembly and attachment base on other portions of the system of this invention preferably resists translation in all directions, so the translation can only occur by driving about the reach lift vehicle (and perhaps somewhat by telescoping action when the boom is somewhat horizontal). When translation in a Y-axis directions required, the vehicle merely travels forward. When translation in the X direction is required, the vehicle can be turned and driven to provide such X-axis translation. When Z-axis translation is required, the boom can be pivoted upward and/or telescoped to provide Z-axis translation.

The saddle assembly partially also provides for rotation about a Z-axis perpendicular to both the X-axis and the Y-axis. This Z-axis lateral pivoting rotation is in one embodiment provided by inserting a pivot joint between a brace holding trough and the collar of the saddle assembly. The trough is a semi-cylindrical structure (or other shape, especially when the brace has a square or other cross-section) with a concave recess into which the brace can be placed. The pivot joint including an upper half of the lower half with the upper half thereof affixed to the trough and the lower half affixed to the collar. Some form of axle extends perpendicularly through the upper and lower halves of the pivot joint (such as a heavy bolt and nut) and which is oriented about a Z-axis to facilitate pivoting about the Z-axis.

Most preferably, the trough includes a clasp on one side of the trough which is rigidly affixed to the trough, and the strap which is flexibly attached to the side of the trough opposite the clasp. The strap can extend over a brace which is resting within the trough and then the strap can be secured to the clasp. The strap has an adjustable length and preferably includes a ratchet thereon which allows for tightening of the strap and securing the brace in removable fashion within the trough.

To operate this attachment, the following methodology is performed in one embodiment. First, the reach lift vehicle has the brace support attachment (such as that particularly disclosed herein) mounted thereon, by the placement of forks of the reach lift vehicle into the fork receivers of the attachment base. The shaft has already been placed within the journal sleeve and secured thereto, with the tip of the shaft extending either to the left or to the right from the attachment base, to a position desired for use of the saddle assembly and pivoting support of the brace. The brace is then set into the trough of the saddle assembly and secured with the strap, clasp and ratchet (or other fastener). The attachment base and associated shaft and saddle assembly are together driven to a location where the brace is to be placed. Preferably the reach lift vehicle is oriented generally toward an area where the brace is to be placed, but can alternatively follow a turning path between a staging area where the brace is loaded onto the saddle assembly of the attachment of this invention to its final position bracing the tilt-up wall (or other use).

The brace is then picked up, typically with such placement occurring about two-thirds of the way toward what is to be an upper end of the brace. With such positioning, the reach lift vehicle carries about two-thirds of the weight of the brace. A single operator (or a group of operators) can relatively easily carry the final third of the weight of the lower end of the brace. If desired, the brace can be held closer to a middle thereof so that the reach lift vehicle carries a larger percentage of the weight of the brace.

The vehicle is then driven to a position where the brace is to be placed, while an individual (or individuals) carry a lower end of the brace and walk behind the reach lift vehicle. As the vehicle approaches the tilt-up wall, the boom of the vehicle can raise the attachment base by pivoting and extending the boom. The individual (or individuals) supporting a lower end of the boom can continue to support the lower end of the boom as this pivoting activity occurs, and also control brace upper end position. The X-axis pivot facilitates brace pivoting into a diagonal installed orientation. The Z-axis pivoting facilitates small lateral adjustment to the location of the brace upper end. This process continues until the upper end of the boom has placed at the upper end of the brace adjacent to the tilt-up construction (or other location) where it is to be attached. The lower end of the brace can then be placed resting on the ground and appropriate steps can be taken to secure the upper end of the brace to the tilt-up wall and lower end of the brace to the ground. Once this attachment of the brace has occurred, the strap is removed from the brace so that the reach lift vehicle with associated attachment structure can be driven away from the brace and repositioned for reuse, such as with a further brace. One methodology for removing the strap from the brace is to have a separate reach lift with a man carrying support at a distal end thereof brought adjacent to the saddle assembly to perform this strap removal and saddle assembly disconnecting procedure after upper and lower end of the brace have been fixed and position.

While this methodology has been described particularly with relation to the placement of braces used in supporting a tilt-up wall of a tilt-up building during construction, this methodology in the attachment of this invention can similarly be utilized for the placement of other braces in other construction environments or non-construction environments. Examples include supporting of elevated forms which are utilized during pouring of concrete, and a myriad of other instances where braces are required. Similarly, other non-brace structures could be placed with this invention, including trusses, buttresses, and other construction equipment, either temporary or permanent.

While the procedure of this invention contemplates manual removal of the strap from the saddle assembly, it is conceivable that an automated mechanism could be utilized which could either manually or automatically be positioned to grip the brace, and then could be remotely activated to release the brace. In one embodiment, the strap is replaced with a pivoting clamp and the clamp is pivotably supported in a manner which allows the clamp to be positioned between a holding position into a releasing position by a servomotor, and the servomotor can be actuated through a radio controlled transmitter and receiver arrangement, and with an appropriate power supply to power the servomotor to cause the clamp to be toggled between a holding and releasing orientation. Such a feature would eliminate the need for utilizing a separate lift to disconnect the brace from the saddle assembly after the brace (or other object) has been appropriately positioned.

While the disclosure herein has contemplated the providing of two degrees of freedom between a reach lift vehicle and the trough of the saddle assembly, other configurations could have as little as one degree of freedom, or more than two degrees of freedom. If only one degree of freedom is provided, this would typically involve elimination of the pivot joint so that rotation about the Z-axis would be eliminated. Z-axis rotation can to some extent be provided by repositioning of the reach lift vehicle. The Z-axis pivoting control provided by the pivot joint or similar structure is beneficial to enable final positioning of the brace to occur manually by an individual (or individuals) at a lower end of the brace (and to some extent at an upper end of the brace) which is often more effective than providing such find positioning control with the reach lift vehicle alone. If more degrees of freedom were provided, this could include at least some limited Y-axis pivoting control, and limited translation motion along X, Y or Z-axis.

While motion relative to three orthogonal directions is contemplated herein, pivoting axes could be provided which are oriented relative to each other in manners which are not necessarily mutually perpendicular and still function according to this invention to provide some degree of elevation control and some degree of lateral repositioning control so that a brace can most effectively be positioned where desired, and while the reach lift vehicle is primarily carrying the weight of the brace and getting a brace close to its final position, before final positioning is accomplished in a manual and simple manner with a small group or just one individual.

While fork interfacing attachment base is shown as a preferred interface which attaches to forks at a distal end of a reach lift vehicle, the lift vehicle could have other structures at a distal end other than the forks, so the attachment base could be appropriately modified for attachment to the distal end of various types of reach lift vehicles. In at least one embodiment, a special purpose vehicle could be constructed having a structure similar to the attachment base (but without the forks receivers typically) affixed to the distal end of the reach lift vehicle. Such an attachment base could maintain an angle which is common with the distal end of typical reach lift vehicles or could be self leveling, so that as the boom is raised, the attachment base would accommodate and maintain a generally parallel orientation.

In at least one embodiment, the attachment base could be configured to also include a man lift cage thereon, and which could be driven either from a cab on the wheeled base of the reach lift vehicle, or could be driven and operated from the man lift cage. The cage is sufficiently close to the tip of the shaft that a worker on the man lift cage could easily reach and disconnect the strap or other holder from the brace after the brace has been positioned where desired and secured. In this way, a single reach lift vehicle could both carry the brace to a desired position and easily facilitate manual disconnect from the brace, once positioning of the brace and securing of the base has been completed.

While it is typically contemplated that a single saddle assembly would support a single brace extending from either a left or right side of the attachment base, it is conceivable the shaft could be made longer and have two opposing tips which are similar to each other and which could each support saddle assemblies thereon. One of the saddle assemblies could remain idol so that an operator (or group of operators) would merely select the saddle assembly which is in the most convenient position for use. Such an orientation of the attachment base with two saddle assemblies, could also conceivably be utilized with two braces attached simultaneously, one in each saddle assembly, and move to a tilt-up or other installation location and be positioned simultaneously, especially for spacing between braces that are similar to the length of the shaft. If the spacing is too much greater or less than a length of the shaft, one brace would first be secured and then detached from the associated saddle assembly, and then the reach lift vehicle would be repositioned with the remaining brace until the remaining brace has been positioned as desired for securing into position, and then removal of the second brace from the second set of assembly could occur, before utilizing the reach lift vehicle to repeat the procedure with further braces. Such a procedure could potentially double the speed with which braces could be set in position.

While one embodiment of this invention is shown attached to a reach lift vehicle, this attachment could be attached to other vehicles and be similarly utilized. For instance, a forklift could utilize the attachment of this invention. Also, a multi-purpose tractor which include forks as an attachment on the front end of the tractor could be attached to the attachment base of this invention for setting of a brace, or the attachment could be otherwise configured to connect to the tractor Other vehicles to which the attachment of this invention could be connected include various different forms of lifts, including scissor lifts.

### OBJECTS OF THE INVENTION

Accordingly, a primary object of the present invention is to facilitate accurate placement of a brace adjacent to a wall, such as a wall of a tilt-up construction building.

Another object of this invention in one embodiment is to enhance safety with which braces are placed adjacent to walls and other structures.

Another object of this invention according to one embodiment is to enhance the ease and simplicity, and minimize a number of personnel required to place a brace, such as adjacent to a wall of a tilt-up building during construction thereof.

Another object of this invention in one embodiment is to provide a method and attachment for utilizing a reach lift vehicle to place a brace, such as adjacent to a wall.

Another object of this invention in one embodiment is to provide an attachment for supporting elongate objects with a construction vehicle.

Another object of this invention in one embodiment is to provide a method for placement of a brace which allows the brace to be tilted and pivoted about two separate axes of rotation while being supported, to facilitate positioning of the brace.

Another object of this invention is to provide an attachment for a reach lift vehicle which can hold a brace in a manner preventing translation of the brace separate from movement of the vehicle, but which allows for at least one of pivoting and/or tilting of the brace relative to the vehicle.

Other further objects of the present invention will become apparent from a careful reading of the included drawing figures, the claims and detailed description of the invention.

### BRIEF DESCRIPTION OF THE DRAWINGS

FIG. 1 is a perspective view of an attachment for a reach lift vehicle which can support a brace thereon, a portion of the brace shown in broken lines supported thereon.

FIG. 2 is a perspective view of a portion of that which is shown in FIG. 1 and with a shaft and saddle assembly exploded apart to illustrate how they are coupled together.

FIG. 3 is a front elevation view of that which is shown in FIG. 2, with parts of the saddle assembly shown assembled together and with a brace in section shown in solid lines strapped to a trough thereof.

FIG. 4 is a right side view of that which is shown in FIG. 4, and with the shaft shown in section.

FIG. 5 is a left side view of that which is shown in FIG. 4.

FIG. 6 is a rear elevation view of that which is shown in FIG. 3.

FIG. 7 is a top plan view of that which is shown in FIG. 3.

FIG. 8 is a top plan view of that which is shown in FIG. 7, and with the brace and saddle assembly pivoted relative to the shaft in a clockwise direction.

FIG. 9 is a top plan view similar to that which is shown in FIGS. 7 and 8, but with the brace and saddle assembly shown pivoted in a counter clockwise direction and illustrating lateral pivoting of the brace relative to the shaft and associated attachment base.

FIG. 10 is a side elevation view of the attachment assembly of FIG. 1 mounted upon front forks of a reach lift vehicle, with portions of the reach lift vehicle other than a tip of the boom cut away.

FIG. 11 is a side elevation view of that which is shown in FIG. 10, and with the brace attached thereto shown elevated relative to its depiction in FIG. 10.

FIG. 12 is a side elevation view of that which is shown in FIG. 11, and with a tilt-up construction wall adjacent thereto and with the reach lift vehicle shown resting upon the ground and with a worker assisting in positioning the brace, and with one brace already positioned supporting the wall.

FIG. 13 is a side elevation view similar to that which is shown in FIG. 12, but after the brace has been position where desired, and before removal of the attachment of this invention from the brace.

### DESCRIPTION OF THE PREFERRED EMBODIMENT

Referring to the drawings, wherein like reference numerals represent like parts throughout the various drawing figures, reference numeral 10 is directed to an attachment which is removably attachable to a reach lift L or other construction vehicle. The attachment 10 is attachable to the reach lift L or other construction vehicle, such as through forks F of the reach lift L and includes a saddle assembly 50 which is configured to support a brace B as it is carried to a wall W or other structure to be braced, such as a tilt-up wall W in tilt-up construction, and also to facilitate elevation and tilting (about a horizontal X-axis) of the brace B as it is placed in position adjacent to the wall W.

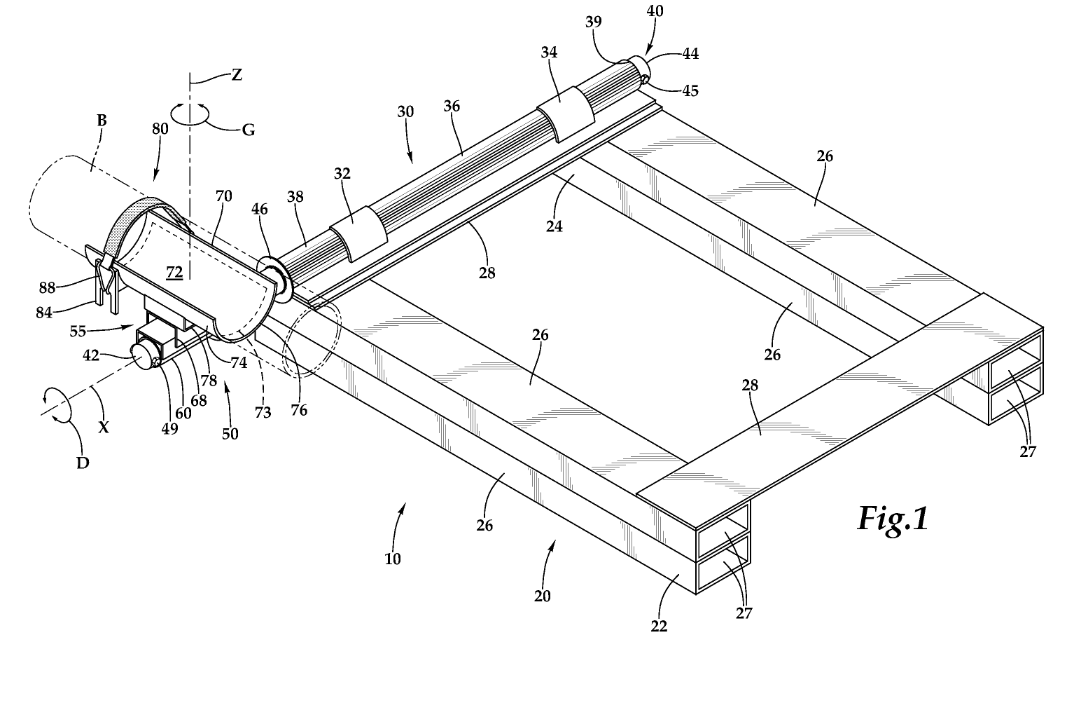

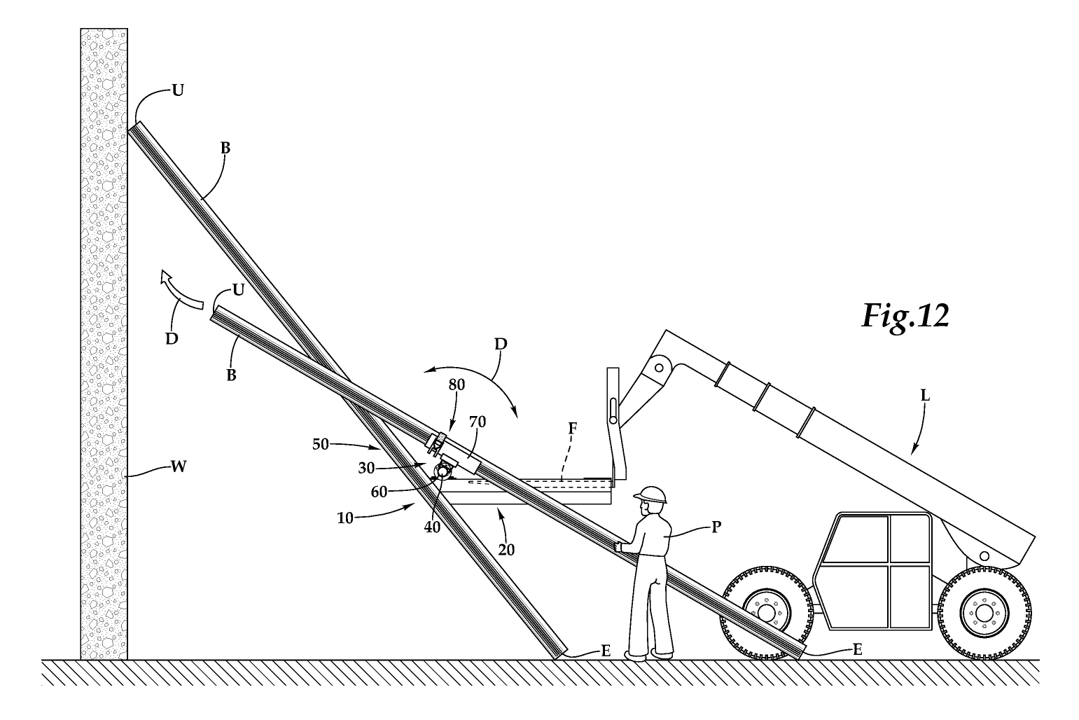

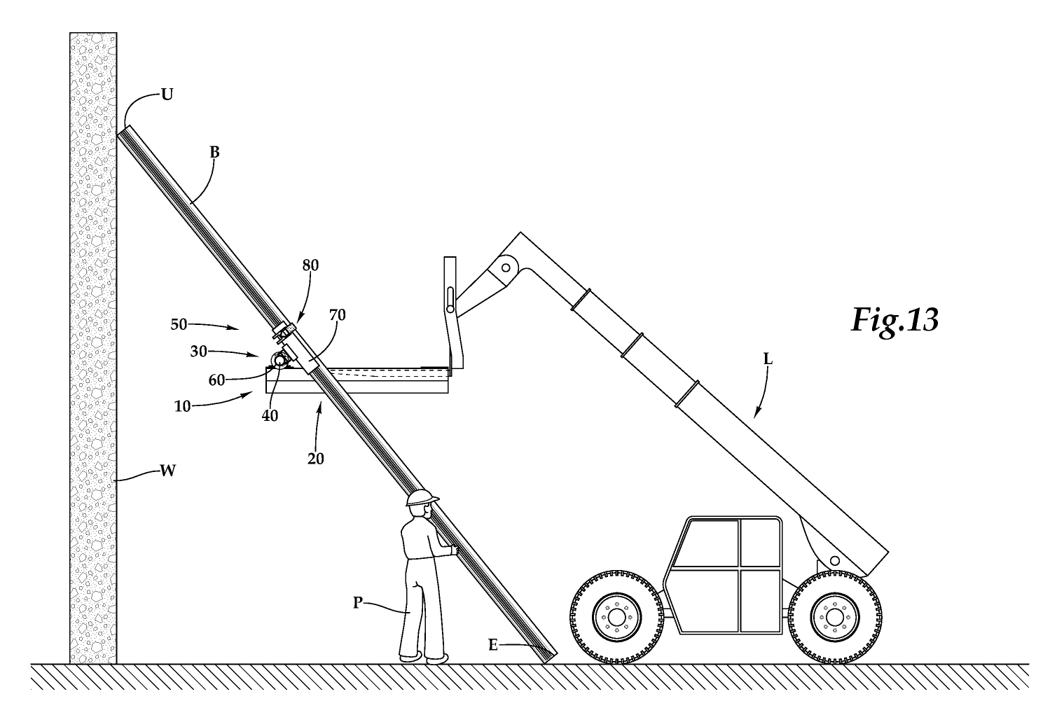

In essence, and with particular reference to FIGS. 1, 2 and 12, basic details of the attachment 10 and overall method of brace B placement are described according to an exemplary embodiment of this invention. The attachment 10 includes a base 20 which is configured to receive forks F of the reach lift L or other construction vehicle therein, for connecting the base 20, and other portions of the attachment 10 supported upon the base 20, to the forks F of the reach lift L. A bearing 30 on the base 20 supports (typically with rotation allowed) a shaft 40 about a horizontal X-axis, to facilitate tilting of a saddle assembly 50 of the attachment 10, relative to the base 20. The saddle assembly 50 is (typically) rotatably supported upon the shaft 40 through a collar 60. A trough 70 is one form of brace B rest which is mounted to the collar 60 typically, through a pivot joint 55. The trough 70 is sized to receive a portion of the brace B therein, with a clasp 80 spanning the trough 70 and holding the brace B within the trough 70 of the saddle assembly 50. The attachment 10 holds the brace B through the saddle assembly 50 so that the reach lift L can lift the brace B into position, such as adjacent to a wall W (FIG. 12). The saddle assembly facilitates tilting about the X-axis, along arrow D, and also preferably through the pivot joint 55 facilitating lateral pivoting about a vertical Z-axis, along arrow G.

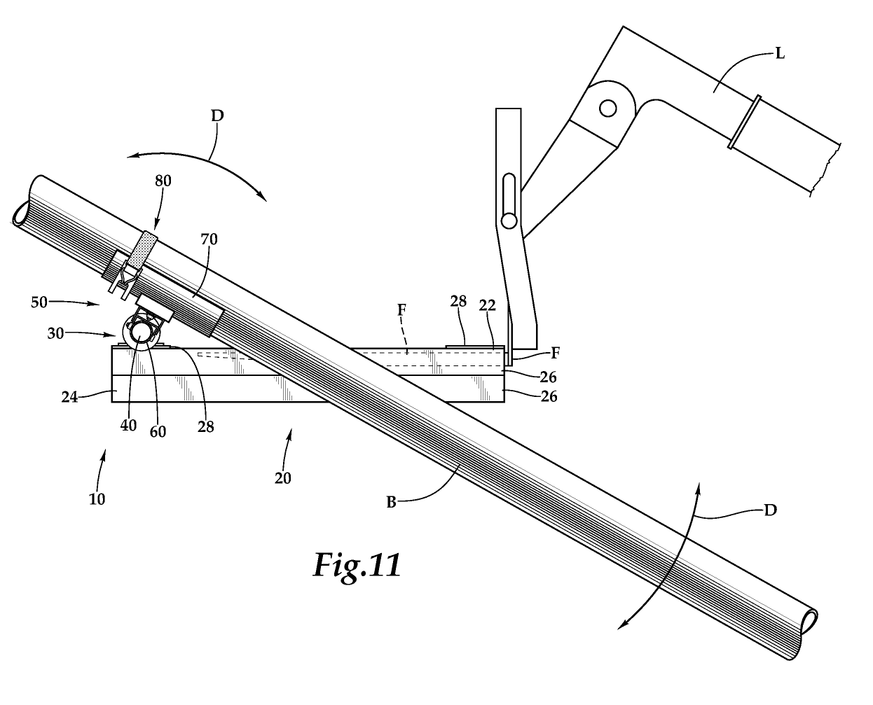

More specifically, and with particular reference to FIGS. 1, 10 and 11, details of the base 20 of the attachment 10 are described, according to this exemplary embodiment. The base 20 provides one form of an interface between forks F or other portions of the reach lift L or other construction vehicle and the attachment 10 and saddle assembly 50 thereof. The base 20 preferably facilitates removable attachability to the reach lift L through the forks F. Thus, the reach lift L is not permanently modified, but can “pick up” the attachment 10, such as with forks F interfacing with the base 20, to readily and easily pick up the attachment 10.

In this embodiment, the base 20 includes a proximal end 22 opposite a distal end 24. A pair of fork receivers 26 extend from the proximal end 22 to the distal end 24, with this pair of fork receivers 26 spaced apart laterally by a distance similar to a spacing between the forks F on the reach lift L. The fork receivers 26 are preferably parallel with each other. In this embodiment, two fork receivers 26 are stacked vertically on top of each other at each lateral side of the base 20, so the bottom one doubles as a skid. Each fork receiver 26 includes a tunnel 27 therein, essentially formed by fork receivers 26 being hollow rigid members with a rectangular cross-section. The fork receivers 26 are formed of high strength rigid material, typically steel.

Frame members 28 extend laterally between the fork receivers 26, maintaining a lateral spacing of the fork receivers 26 away from each other, generally matching a spacing between the forks F on the reach lift L. As an option, fork receivers 26 could be adjustable so that spacing between fork receivers 26 could be modified, allowing the attachment 10 and base 20 thereof to facilitate attachment to forks F of a reach lift L having various different spacings.

Furthermore, while a reach lift L is contemplated in this embodiment, a forklift of some form could alternatively be utilized, or a tractor or other construction vehicle fitted with forks F could be alternatively utilized with this attachment 10. As a further option, the reach lift L could be replaced with a dedicated construction vehicle having the attachment 10 permanently or removably attachable to some elevatable operating point on an upper end of such a vehicle. Thus, interfacing of the base 20 or other portions of the attachment assembly 10 through forks F is not strictly required.

The base 20 includes a bearing 30 thereon, preferably adjacent to the distal end 24 of the base 20. This bearing 30 facilitates tilting rotation about a horizontal X-axis, and along arrow D (FIGS. 1, 2 and 12). The bearing 30 in this embodiment includes a left support 32 spaced laterally from a right support 34. A journal 36 is held in fixed lateral orientation by the left support 32 and right support 34. The journal 36 is a hollow elongate tube extending between a left opening 38 and a right opening 39 on lateral sides of the base 20. The shaft 40 passes through this bearing 30 by passing through the journal 36, so that the shaft 40 can rotate about its elongate center line, which is aligned with the X-axis, which is typically oriented horizontally.

While this general arrangement is disclosed herein, it is conceivable that the left support 30 and right support 34 can directly hold the shaft 40 and facilitate rotation of the shaft 40 relative to the supports 32, 34, and without the journal 36. Stated alternatively, the journal 36 and shaft 40 could be a common element. While the left support 30 and right support 34 are shown as inverted U-shaped structures, they could be formed as complete circular bearings, such as roller bearings, static bearings, etc. Lubrication fittings could be provided on the supports 32, 34 or in the journal 36 to facilitate greasing of surfaces between the journal 36 and the shaft 40 (or between the supports 32, 34 and the journal 36/shaft 40 if the journal 36 and shaft 40 are in someway combined).

The shaft 40 is an elongate rigid structure, typically formed of steel, and which could be hollow or solid, and would typically be hollow. The shaft 40 extends between an extended end 42 and an anchor end 44. The shaft 40 is long enough to extend out of both the left opening 38 and right opening 39 of the journal 36. A capture pin 45 can pass through a hole extending laterally through the anchor end 44 of the shaft 40. This capture pin 45 holds the shaft 40 within the journal 36 so that it cannot fail out of the opposite end of the journal 36.

While FIG. 1 depicts the extended end 42 extending from the left end 38 of the journal 36 and with the anchor end 44 and capture pin 45 adjacent to the right opening 39 of the journal 36, the capture pin 35 can be removed and the shaft 40 removed and placed into the journal 36 in an opposite orientation, such that the shaft 40 is reversible, and so that the saddle assembly 50 can be placed at either a left side or extending from the right side of the base 20 of the attachment 10.

Near the extended end 42 of the shaft 40, a pair of plates 46, 48 are provided which preferably extend radially from the centerline of the shaft 40. These plates 46, 48 include a bearing plate 46 closer to the anchor end 44 of the shaft 40, and a standoff plate 48 closer to the extended end 42 and the bearing plate 46. Spacing between the bearing plate 46 and standoff plate 48 define a distance that the saddle assembly 50 is spaced laterally from the base 20. The plates 46, 48 are preferably fixed to the shaft 40 defining a fixed lateral spacing for the saddle assembly 50 away from the base 20.

As an alternative, at least one of the plates 46, 48 could be configured to be removably attachable to the shaft 40 in an adjustable manner, so that such spacing could be modified. As one example, a series of holes could pass through the shaft 40 in an orientation lateral to a centerline of the shaft 40, and one of the plates 46, 48, typically the standoff plate 48, could be moved laterally along the shaft 40 and then secured in place by fasteners passing through such holes in the shaft 40, to anchor the standoff plate 48 at a desired position on the shaft 40. Other options for adjustably spacing the saddle assembly 50 from the base 20 could include forming the shaft 40 from multiple portions which telescope together, and with the standoff plate 48 on one portion of such a telescoping shaft and with the bearing plate 46 on a separate portion of such a telescoping shaft.

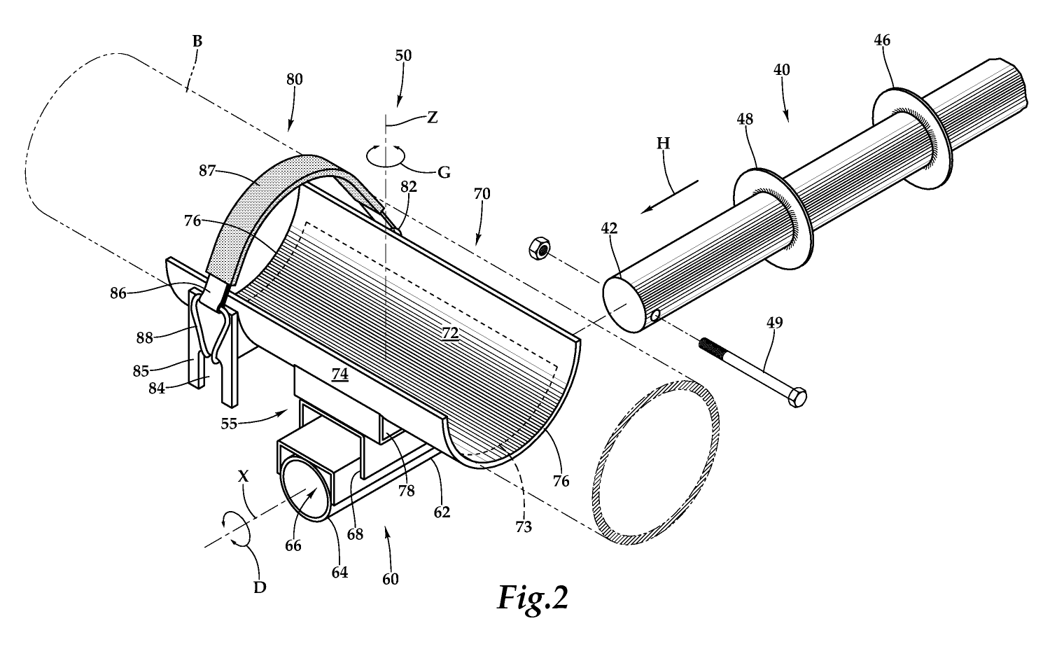

Lateral spacing of the saddle assembly 50 away from the base 20 accommodates reach lift L or other construction vehicles having different widths, and allowing the brace B to remain lateral to the reach lift L and to be easily handled by personnel P (FIG. 12). Furthermore, most preferably a pivot joint 55 is provided associated with the saddle assembly 50, which allows for some lateral pivoting, about a Z-axis which extends vertically, or at least somewhat vertically (defined as closer to vertical than to horizontal), about arrow G (FIGS. 1 and 2). Thus, a person P can handle the brace B and assist in positioning even if the saddle assembly 50 is not spaced laterally very far away from the base 20 of the attachment assembly 10, and lateral to the forks F of the reach lift L.

A tip pin 49 passes through a hole at the extended end 42 of the shaft 40, in this exemplary embodiment. The tip pin 49 acts as a cap at the end of the shaft 40 so that the saddle assembly 50 can be maintained upon the shaft 40, between this tip pin 49 and the bearing plate 46. Other forms of caps or other lateral restraints on the shaft 40 could alternatively be provided to keep the saddle assembly 50 upon portions of the shaft 40 between the standoff plate 48 and the extended and 42. The tip pin 49 is removably attachable to the shaft 40, so that the tip pin 49 can be removed and the saddle assembly 50 placed upon the shaft 40, and then the tip pin 49 replaced, to secure the saddle assembly 50 to the shaft 40. If the saddle assembly needs to be reversed when the journal 36 and/or shaft 40 are reversed relative to the base 20, such removability of the saddle assembly 50 from the shaft 40 can also be performed when such reversing to an opposite side of the reach lift L is desired. Furthermore, such removability allows for saddle assemblies 50 of different configurations to be swapped, or to facilitate repairs should one portion of the attachment 10 become damaged. If desired, multiple holes can pass through the shaft 40 adjacent to the extended end 42, and so the positioning of the saddle assembly 50 can vary to some extent between the standoff plate 48 and the shaft 40. As a further alternative, and as a replacement for the plates 46, 48, holes passing through the shaft 40 and pins, such as bolt and nut pairs, can be provided in place of such plates 46, 48.

With particular reference to FIGS. 1-6, details of the saddle assembly 50 are described, according to this exemplary embodiment. The saddle assembly 50 provides an exemplary interface between the brace B and the shaft 40 rotatably supported by the bearing 30 upon the base 20, to securely hold the brace B to the attachment 10, while allowing the brace B to tilt (about arrow D (FIG. 2)) and optionally also to pivot laterally (about arrow G). The saddle assembly 50 in this embodiment includes a collar 60 mounted on the shaft 40, and with a trough 70 coupled to the collar 60 through the pivot joint 55 (which option could be illuminated if lateral pivoting is not required). A clasp 80 is provided as a form of fastener to securely hold the brace B within the trough 70 or against some other form of brace rest.

The collar 60 in this embodiment is a hollow cylindrical structure formed of rigid material, such as steel, and having a hollow bore 66 extending between an inner end 62 and an outer end 64. The inner end 62 is typically adjacent to the standoff plate 48 and the outer end 64 is typically adjacent to the tip pin 49 and adjacent to the extended end 42 of the shaft 40. The collar 60 is allowed to rotate about the X-axis (along arrow D of FIGS. 1, 2 and 10-12).

As an alternative to the collar 60 rotating relative to the shaft 40, the collar 60 could be fixed to the shaft 40, and the shaft 40 allowed to rotate relative to the bearing 30, such as by rotation relative to the journal 36. However, such tilting rotation about the X-axis, along arrow D, could be provided at multiple locations or at any one interface between either the collar 60 and the shaft 40, or between the shaft 40 and the journal 36, or between the journal 36 and the supports 32, 34. It is further conceivable that such tilting rotation could be facilitated by pivoting of a structure from which the forks F of the reach lift L is attached. For instance, an upper point on the reach lift L could be pivotable with hydraulics. Such pivoting control of the forks F could be utilized to provide pivoting rotation about arrow D, as another alternative for providing this tilting support. Most preferably, both the collar 60 can rotate relative to the shaft 40 and the shaft 40 can rotate relative to the journal 36. In this manner, the brace B is free to tilt and keeps its lower end E on the ground, unless picked up by a person P or otherwise elevated by some other item.

When placing a brace B, it is not generally necessary that the brace B can be entirely picked up off of the ground, as its placement will involve the lower end E interfacing with the ground, and it is only important that the attachment 10 can elevate the upper end U, such as for attachment to a wall W or other structure to be braced. As an option, a hole could be provided through the collar 60 into the shaft 40, which could allow for locking of the collar 60 relative to the shaft 40, and similarly holes and pins could be utilized for locking the shaft 40 relative to the journal 36 or other portions of the bearing 30, so that an operator would have control over which portions of the attachment 10, if any, are allowed to facilitate tilting rotation about a horizontal axis, or other axis which is more horizontal then vertical, and generally along arrow D.

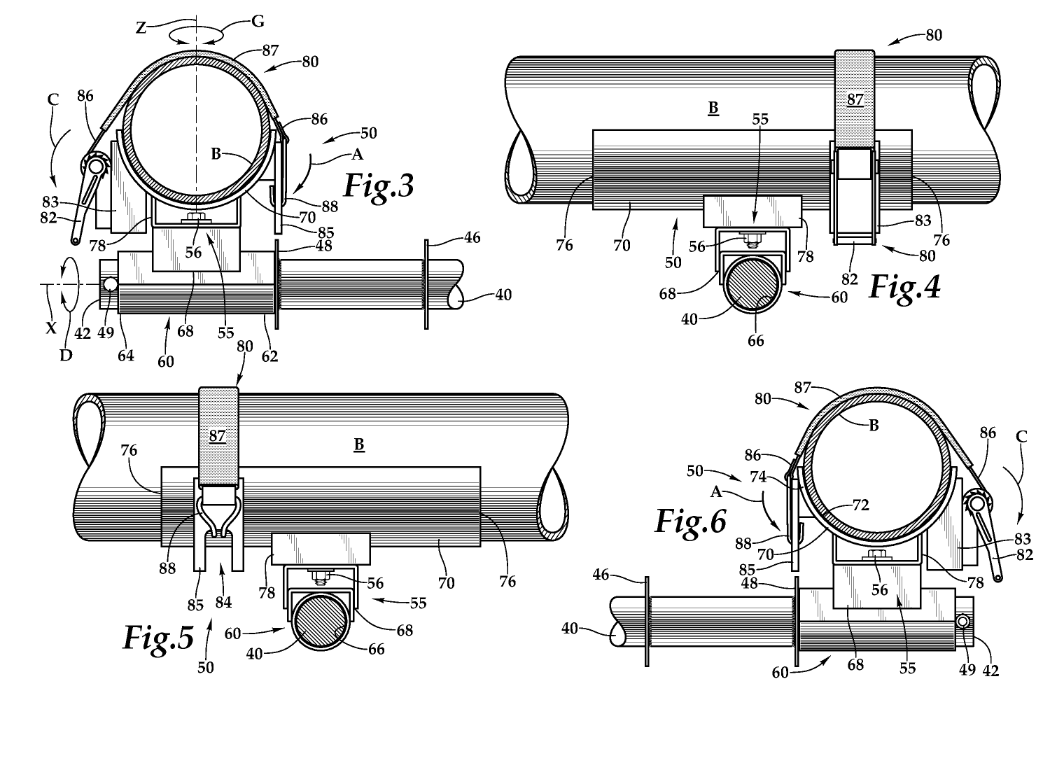

A lower bracket 68 is preferably affixed to the collar 60, and in this example embodiment is provided as two separate inverted U-shaped structures affixed to upper portions of the collar 60 in a staged fashion. Such a structure can be provided directly adjacent to the collar 60 and with the central web of the lower structure touching the collar 60. A second such structure can have lateral legs fixed to the lower such structure, and elevated somewhat so that portions of a bolt/nut pair 56 associated with the pivot joint 55 can reside between these two structures forming the lower bracket 68 (FIGS. 3-6).

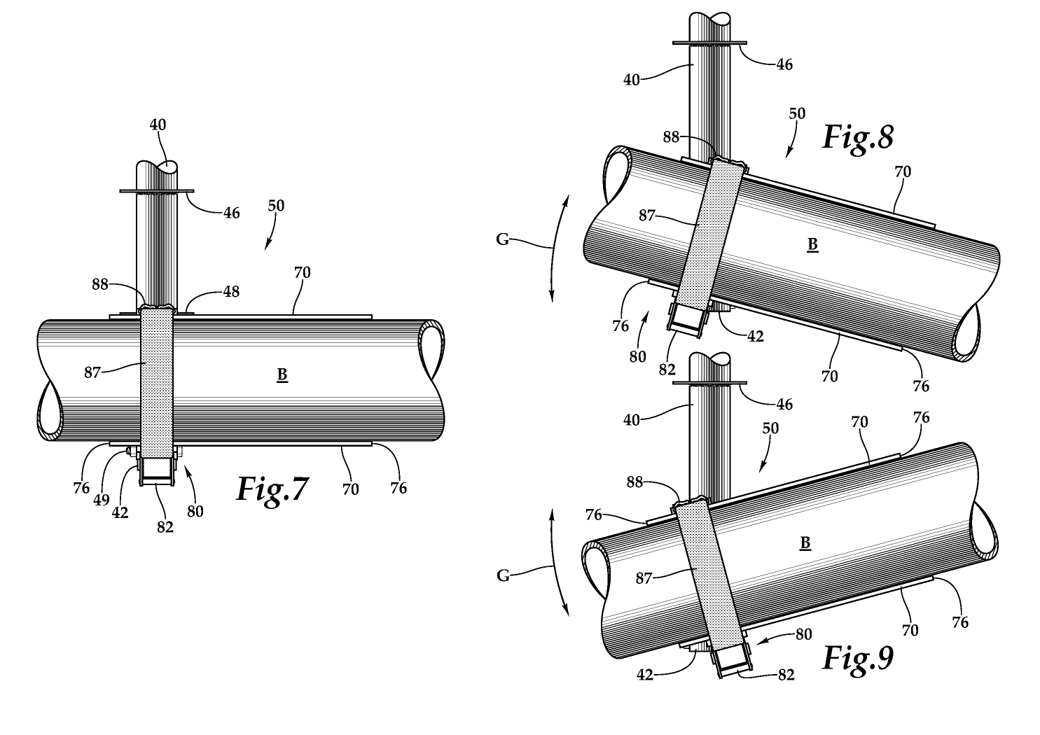

The lower bracket 68 cooperates with a similar but inverted upper bracket 78 affixed to the trough 70 (or other brace rest), so that the bolt/nut pair 56 (or other pivot pin) passing through the two brackets 68, 78 can provide the pivot joint 55 in one embodiment. The bolt/nut pair 56 extend along a Z-axis which preferably extends vertically, but at least extend more vertically than horizontally, to facilitate pivoting lateral rotation along arrow G (FIGS. 1-3). FIGS. 7-9 further depict how trough 70 can rotate about the pivot joint 55 along arrow G laterally to the left or to the right, with a neutral position shown in FIG. 7.

With particular reference to FIGS. 1-6, details of the trough 70 are described according to an exemplary embodiment. The trough 70 provides a preferred form of interface directly adjacent to the brace B. The trough 70 is semi-cylindrical in form, and open in an upwardly facing direction, to allow the brace B to rest down into the trough 70. Through utilization of the clasp 80, the brace B can then be removably held within the trough 70. As an alternative to the trough 70, some other form of brace B rest could be provided as part of the saddle assembly 50, which could merely be a structure which is accessible from above and upon which the brace B can rest. Especially when the clasp 80 or some other fastener is provided over the upper portion of the brace B, any such underlying brace B rest could facilitate temporary attachment of the brace B to the attachment 10 in alternative embodiments.

In this particular embodiment, the trough 70 includes an inner surface 72 opposite an outer surface 74 which are spaced a constant distance therefrom, defining a wall thickness for the trough 70 and with each of the surfaces 72, 74 being semi-cylindrical, and most particularly hemi-cylindrical. The trough 70 extends between ends 76 which are preferably oriented in parallel planes perpendicular to the inner surface 72 and outer surface 74. A liner 73 can be provided adjacent the inner surface 72. Such a liner 73 can be provided with a high friction character, such as being formed of a rubber material. In this manner, the brace B is caused to better resist translation relative to the trough 70, and works with the clasp 80 or other fastener for such secure holding of the brace B. The upper bracket 78 forming a portion of the pivot joint 55 is preferably rigidly attached to the outer surface 74 of the trough 70 on an undersurface thereof. The upper bracket 78 preferably has a middle web thereof which is spaced away from the trough 70 sufficiently so that a head or nut of a bolt/nut pair 56 (or other pivot pin) can be placed and accessed, and facilitate rotation of the trough 70 relative to the collar 60, about the Z-axis, for lateral pivoting about arrow G.

With particular reference to FIGS. 1-6, details of the clasp 80 are described according to this exemplary embodiment. The clasp 80 provides an exemplary form of fastener for holding the brace B to the trough 70 or other brace rest within the saddle assembly 50. The clasp 80 in this form includes a strap 86 of elongate flexible high strength material, such as woven nylon web material, similar to that from which seat belts are made, and typically with a sleeve 87 placed over the strap 86. The sleeve 87 can be of high frictional character and can be potentially replaceable, so that a portion of the clasp 80 abutting the brace B can be replaced should it become worn over time.

The strap 86 preferably is connected at one side through a lever mechanism 82 pivotably supported on a support bracket 83. A hook 88 is provided on an end of the strap 86 opposite of the lever mechanism 82, with the hook 88 attachable within a slot 84 in a catch bracket 85 fixed on a side of the trough 70 opposite to where the support bracket 83 is fixed. The strap 86 can thus span over a brace B and have the hook 88 interface with the slot 84 in the catch bracket 85 (by motion along arrow A of FIGS. 3 and 6). This strap 86 can be tightened somewhat, and then the lever mechanism 82 can be pivoted (along arrow C of FIGS. 3 and 6) to complete the tight securing of the strap 86 and associated sleeve 87 over the brace B.

The support bracket 83 and catch bracket 85 are preferably each affixed to the trough 70 or other appropriate portions of the saddle assembly 50 at opposite ends of the clasp 80. The lever mechanism 82 is preferably adjustable to take up the slack in the strap 86 before it is pivoted (along arrow C) for final tightening thereof. Such a lever mechanism 82 can include a ratchet pawl by which the trap 86 can be tightened somewhat. The lever mechanism 82 can be pivoted (along arrow C of FIGS. 3 and 6) to complete the tight securing of the strap 86 and associated sleeve 87 over the brace B. Other forms of clasp 80 could alternatively be utilized or other fasteners utilized for temporary securing of the brace B within the trough 70 or other portion of the saddle assembly 50.

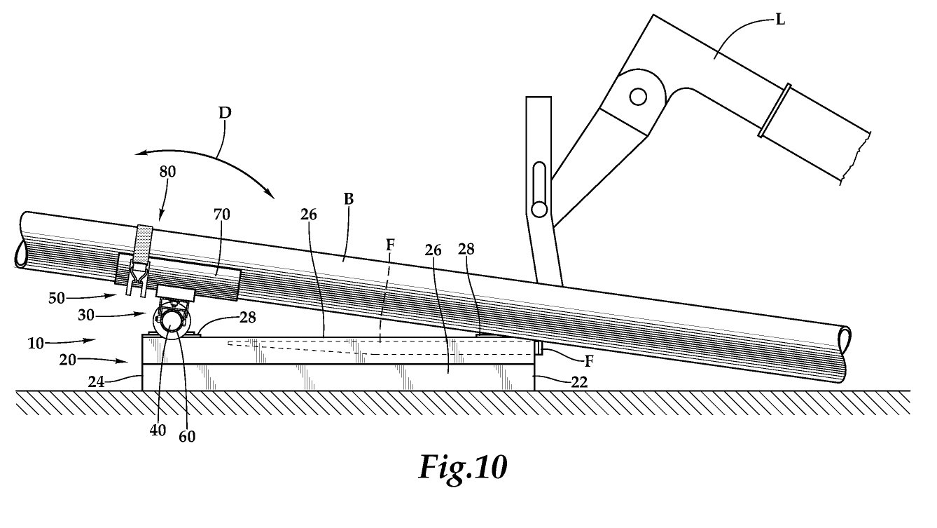

With particular reference to FIGS. 10-12, details of this invention are described which illustrate use and operation of the invention according to this exemplary embodiment. Initially, and as generally depicted in FIGS. 1-6, the brace B is placed within the trough 70 and the clasp 80 utilized for securing the brace B to the clasp 80. This occurs while the forks F of the reach lift L are on or near the ground (FIG. 10). Once the brace B has been so secured, the reach lift L can be elevated at its forks F cause portions of the brace B to be elevated. The brace B is preferably attached near a midpoint thereof, but closer to the upper end U then to the lower end E. In this way, as the forks F are elevated, and the brace B is lifted, the upper end U is elevated, but the lower end E remains adjacent to the ground.

Preferably the brace B is attached to the saddle assembly 50 of the attachment 10 close enough to the center of the brace B, that a person P can easily lift the lower end E slightly, with most of the weight of the brace B carried by the reach lift L. As the forks F are elevated, the brace B is caused to rotate (along arrow D in a tilting fashion, somewhat). Typically, the brace B is picked up at a first location spaced from where it is to be utilized. The reach lift L is then driven to the place with the brace B is to be placed for use, with a person P walking alongside the reach lift L and holding the lower end E of the brace B off of the ground. As an alternative, the brace B could be drug along the ground at its lower end E.

Once at the brace B desired position (FIG. 12) the forks F can be further elevated, and typically upper portions of the reach lift L telescoped, to cause both elevating of the brace B, and further tilting rotation (about arrow D) of the brace B directly adjacent to the wall W or other structure to be braced by the brace B. The person P assists in fine positioning of the brace B, as well as typically an operator of the lift L.

While the reach lift L is shown with a cab on a wheeled chassis thereof, it is conceivable that the reach lift L could be of a type which is driven by an operator standing upon a platform adjacent to or in replacement of the forks F. Attachment 10 of this invention could be mounted to such a platform, so that one person P would typically hold the lower end of the brace B, while a second operator would be on such a platform and controlling the reach lift L. It is also conceivable that placement of the brace B could be performed by a single person standing upon such a platform, and merely allowing the lower end E to rest up on the ground. With further elevating and telescoping of the reach lift L or otherwise positioning, the brace B is finally brought into a final position with the upper end U abutting the wall W or other structure to be braced, and with the lower end E positioned where desired for anchoring of the lower end E to the ground. Typically, the lower end E of the brace B is then affixed to the ground with appropriate ground anchoring structures, and the upper end U is typically fastened to the wall W or other structure to be braced in a secure fashion adjacent to the upper end U.

As a final step, the clasp 80 or other fastener associated with the saddle assembly 50 is disconnected from the brace B. Such disconnecting could occur by a person standing upon a platform at an upper end of the reach lift L, or could be performed by other personnel on other reach lift type vehicles or other vehicles, or upper ladders, so that they can access the clasp 80 for disconnecting thereof. The reach lift L is then repositioned and moved away from the brace B, and then the reach lift L is then typically utilized to drive to an area where a further brace B can be picked up and further bracing and placement of braces B can occur.

To facilitate this final step, it is conceivable that the clasp 80 or other fastener could be configured to operate in an automatic fashion. For instance, the fastener could include a pair of claws which move relative to each other, or with one fixed claw and one movable claw, so that a structure general in the form of a grapple can be provided, which clamps and grabs the brace B. Such a clamping structure could conceivably cooperate with the trough 70 or some other brace rest, or such a grapple like clamping structure could itself also provide such a brace rest upon which the brace B is supported. Such grapple a clamp with separate claws can have hydraulic actuators couple to one or both of the claws for opening and closing thereof, or could utilize solenoids, pneumatics, cables, levers, or other actuators, either powered or manual, for releasably grasping the brace B. Once the brace B is positioned at a final location, such an automatic or manual fastener would be caused by an operator to release the brace B, and no personnel would need to be utilized for such detachment of the clasp 80 or other fastener from the brace B.

This disclosure is provided to reveal a preferred embodiment of the invention and a best mode for practicing the invention. Having thus described the invention in this way, it should be apparent that various different modifications can be made to the preferred embodiment without departing from the scope and spirit of this invention disclosure. When embodiments are referred to as “exemplary” or “preferred” this term is meant to indicate one example of the invention, and does not exclude other possible embodiments. When structures are identified as a means to perform a function, the identification is intended to include all structures which can perform the function specified. When structures of this invention are identified as being coupled together, such language should be interpreted broadly to include the structures being coupled directly together or coupled together through intervening structures. Such coupling could be permanent or temporary and either in a rigid fashion or in a fashion which allows pivoting, sliding or other relative motion while still providing some form of attachment, unless specifically restricted.

What is claimed is:

1: An attachment for a reach lift vehicle including forks on the front end thereof, comprising in combination:
an attachment base including a pair of fork receivers spaced apart a distance similar to forks on the reach lift;
a shaft extending non-parallel to each of the fork receivers;
a saddle assembly attached to the shaft at an end of the shaft extending laterally away from the attachment base, and tiltable relative to said attachment base about a central axis of the shaft; and
a fastener on the saddle assembly configured to removably fasten over the trough and hold at least a portion of an elongate object within the trough, for carrying by the reach lift through the attachment.

2: The attachment of claim 1 wherein said saddle assembly includes a trough pivotably attached to the shaft for pivoting in a manner not parallel with the central axis of said shaft; and
wherein a collar is interposed between said trough and said shaft, said trough coupled to said shaft through said collar, said collar having a hollow core with said shaft passing therethrough.

3: The attachment of claim 1 wherein said saddle assembly includes a trough pivotably attached to the shaft for pivoting in a manner not parallel with the central axis of said shaft; and
wherein a pivot joint is interposed between said trough and said shaft, said pivot joint pivoting in a manner about a pivoting axis non-parallel with the central axis of said shaft.

4: The attachment of claim 3 wherein said pivot joint includes a lower bracket supported by said shaft and an upper bracket fixed to said trough, said upper bracket and said lower bracket each having holes therein and spaced vertically from each other with a pivot pin passing through said holes in said upper bracket and said lower bracket.

5: The attachment of claim 1 wherein said shaft includes a bearing plate spaced from a standoff plate, said shaft supported relative to the fork receivers on a side of said bearing plate spaced from said standoff plate, and with said trough tiltingly attached to said shaft on a side of said standoff plate opposite side bearing plate.

6: The attachment of claim 5 wherein portions of said shaft on a side of said bearing plate opposite said standoff plate are attachable extending laterally into opposing directions relative to the front forks of the reach lift vehicle, such that said shaft is reversible.

7: The attachment of claim 1 wherein said fastener includes a clasp including an elongate strap sized to span said trough and the elongate object when the elongate object is resting within said trough.

8: A brace supporting attachment for a construction vehicle, the construction vehicle including a ground supported frame and an elevatable operating point to which attachments are removably supported, the brace supporting attachment comprising in combination:
a base removably coupled to the operating point of the construction vehicle;
a brace rest coupled to said base;
a clasp removably holding an elongate brace to said brace rest; and
said clasp at least partially tiltable when said elongate brace held by said clasp undergoes tilting rotation.

9: The brace supporting attachment of claim 8 wherein said brace rest is coupled to said base through a tilt joint.

10: The brace supporting attachment of claim 9 wherein said fastener is in the form of a clasp which tilts with said brace rest.

11: The brace supporting attachment of claim 9 wherein said brace includes an elongate shaft tiltably supported about a central axis of said shaft, with a collar having a hollow core positioned upon said shaft with said shaft passing through said hollow core, said brace rest supported upon said collar, said collar tiltable relative to said base.

12: The brace supporting attachment of claim 11 wherein said brace rest includes a semi-cylindrical trough, and with said clasp spanning over an open portion of said semi-cylindrical trough.

13: The brace supporting attachment of claim 9 wherein a pivot joint is interposed between said brace rest and said base, said pivot joint pivoting in a manner about a pivoting axis extending at least partially vertically.

14: The brace supporting attachment of claim 13 wherein said pivot joint includes a lower bracket supported by a shaft extending laterally from said base and an upper bracket fixed to said brace rest, said upper bracket and said lower bracket each having holes therein and spaced vertically from each other with a pivot pin passing through said holes in said upper bracket and said lower bracket.

15: The brace supporting attachment of claim 14 wherein said fastener is in the form of a clasp which tilts with said brace rest;
wherein said shaft is an elongate shaft tiltably supported about a central axis of said shaft, with a collar having a hollow core positioned upon said shaft with said shaft passing through said hollow core, said brace rest supported upon said collar, said collar tiltable relative to said base; and
wherein said brace rest includes a semi-cylindrical trough, and with said clasp spanning over an open portion of said semi-cylindrical trough.

16: The brace supporting attachment of claim 9 wherein said fastener includes a clasp including an elongate strap sized to span the brace when the brace is resting upon said brace rest.

17: The brace supporting attachment of claim 16 wherein said elongate strap includes a hook at a distal end thereof, and wherein said brace rest includes a support bracket opposite a catch bracket, and with a catch structure removably coupleable to said hook and with said support bracket supporting a lever mechanism on a portion of said strap spaced from said hook, said lever mechanism pivotable to tighten said strap after said hook is coupled to said catch mechanism to tightly secure the brace to said brace rest.

18: A method for placing a brace adjacent to a wall-like structure, including the steps of:
placing a brace upon a brace rest, the brace rest located upon an attachment for a construction vehicle, the construction vehicle including a ground supported frame and an elevatable operating point to which attachments are removably supported, the attachment including a base removably coupled to the operating point of the construction vehicle the attachment including a brace rest coupled to the base;
securing the brace against the brace rest with a fastener, the fastener removably holding the elongate brace to the brace rest, and the fastener at least partially tiltable when the elongate brace held by the fastener undergoes tilting rotation;
moving the construction vehicle with the brace attached thereto to a position for brace attachment to the wall;
lifting the brace through the construction vehicle to elevate an upper end of the brace to a desired elevation for attachment to the wall;
securing the brace in a desired position against the wall and against ground adjacent to the wall; and
removing the fastener from the brace.

19: The method of claim 18 wherein said moving step includes having a person hold a lower end of the brace opposite the upper end of the brace while the construction vehicle carries a majority of weight of the brace.

20: The method of claim 19 wherein said placing step includes a pivot joint facilitating pivoting of the brace rest relative to the elevatable operating point of the vehicle, and both pivoting and tilting the brace relative to the operating point of the construction vehicle during at least one of said placing step, said lifting step, said moving step and/or said securing step.
